(19) United States
(12) Patent Application Publication
(10) Pub. No.: US 2015/0146269 A1
(43) Pub. Date: May 28, 2015

(54) HOLOGRAPHIC CONTENT PROVIDING METHOD, AND HOLOGRAPHIC CONTENT PROVIDING APPARATUS AND DISPLAY APPARATUS USING THE METHOD

(71) Applicant: Electronics and Telecommunications Research Institute, Daejeon (KR)

(72) Inventors: Beom Ryeol LEE, Daejeon (KR); Ho Yong SEO, Daejeon (KR); Seung Taik OH, Seoul (KR); Chi Young HWANG, Daejeon (KR); Wook Ho SON, Daejeon (KR); Il Kwon JEONG, Daejeon (KR)

(21) Appl. No.: 14/555,461

(22) Filed: Nov. 26, 2014

(30) Foreign Application Priority Data
Nov. 27, 2013 (KR) 10-2013-0145339
Jul. 11, 2014 (KR) 10-2014-0087501

(51) Int. Cl. G03H 1/08; G03H 1/00; G03H 1/22

(52) U.S. Cl. CPC G03H 1/0866; G03H 1/08; G03H 1/2294; G03H 1/0005; G03H 2001/0883; G03H 2001/0061
USPC 359/9

(57) ABSTRACT

A holographic content providing method, and a holographic content providing apparatus and a display apparatus using the method may capture and generate holographic content using a real object, a virtual object and lighting information, and may conduct integrated processing on the generated holographic content, such as direct edition, advance visualization, data format conversion, element technologies for optical reconstruction and manufacture process management techniques of holographic content, thereby producing ultrahigh-quality interactive holographic content.

### CROSS-REFERENCE TO RELATED APPLICATIONS

This application claims the benefit of Korean Patent Application No. 10-2013-0145339 and of Korean Patent Application No. 10-2014-0087501, respectively filed on Nov. 27, 2013 and Jul. 11, 2014, in the Korean Intellectual Property Office, the disclosures of which are incorporated herein by reference.

### BACKGROUND

1. Field of the Invention

The following description relates to a holographic content providing method, and a holographic content providing apparatus and a display apparatus using the method, and more particularly, to a holographic content providing method displaying holographic content in an optical manner using a real object and a virtual object, and a holographic content providing apparatus and a display apparatus using the method.

2. Description of the Related Art

Digital holographic content is represented with a result of numerically calculating a light transmission model, expressed in a formula, with respect to a phase change of light reflected on surfaces of a real object and a three-dimensional (3D) virtual object. Here, the digital holographic content is present by generating a fringe pattern form of complex data and storing data of the generated fringe pattern form in a digital data form as successive data per temporal frame.

An analog hologram generates a fringe pattern through interference between object waves entering a hologram storage medium as light from a laser projects on an object and is reflected and reference waves directly entering the hologram storage medium. The analog hologram records the fringe pattern generated by the interference in the hologram storage medium. To reproduce the recorded analog hologram, the reference waves used in a hologram recording process are allowed to enter the hologram storage medium in the same direction to be diffracted, thereby reproducing a hologram which is the same as the object at an original position of the object.

Here, since an analog hologram is not changed once generated, a new hologram recording process is involved whenever an object changes. Further, when the analog hologram is reproduced in an optical method, there are restrictions in resolution of the hologram reproduced in the optical method and visible volume of an observer and an ultrahigh-capacity spatial bandwidth is required for a hologram display to provide a size and viewing angle similar to those of a traditional 3D image display.

Meanwhile, when a digital hologram is generated, a principle of generating a hologram fringe pattern by interference between object waves of an object and reference waves is computer-modeled and computational processing is carried out through the model. A result of computational processing is a two-dimensional (2D) complex data form. Further, spatial light modulation is needed to reconstruct the digital hologram in the optical method, for which a multifunctional spatial light modulator (SLM) that performs amplitude modulation, phase modulation, or the like, is used. The digital hologram loads digital hologram data, obtained by numerical calculation of light transmission distribution from the 3D modeled data, into the SLM and applies a laser, thereby reconstructing a hologram in the optical method by light distraction.

However, a reproduced image size and observable viewing angle of the optically reconstructed hologram of the digital hologram relate to minuteness of a pixel pitch of the SLM. That is, although the more minute a pixel pitch is, the greater a viewing angle of the reconstructed hologram is, integration of the pixel pitch is limited in a semiconductor manufacture process, causing restrictions in practical use of the digital hologram.

Consequently, conventional digital hologram technology is still at simple calculation of a computer generated hologram (CGH) in data processing and at development of relative high-speed algorithm technology. Further, the conventional digital hologram technology is still at generating stages of a single hologram due to a terabyte amount of data and computational amount.

### SUMMARY

An aspect of the present invention provides a holographic content providing method which generates holographic content on a real object using a plurality of hardware and software algorithms and utilizes a shading model for a virtual object and lighting information to effectively improve image quality of the real object, and a holographic content providing apparatus and a display apparatus using the method.

Another aspect of the present invention also provides a holographic content providing method capable of optically simulating ultrahigh-quality volume hologram by employing a holographic content authoring technique of autonomously editing and composing fringe data of holographic content and by employing a high-speed rendering technique for advance visualization of holographic content, and a holographic content providing apparatus and a display apparatus using the method.

Still another aspect of the present invention also provides a holographic content providing method enabling holographic content to be handled as a new digital media by employing a method of adaptively converting the holographic content to a data format of a display apparatus for displaying digital holographic content in an optical reconstruction method, by employing a user interaction technique and by producing optimized digital holographic content through verification of a reconstructed image, and a holographic content providing apparatus and a display apparatus using the method.

According to an aspect of the present invention, there is provided a holographic content providing method based on distributed processing performed by a holographic content providing apparatus, the method including: generating holographic content by capturing a real object, a virtual object and light information; editing the holographic content using object data of the generated holographic content; advance-visualizing a result of three-dimensional (3D) rendering the holographic content; and converting a data format of the object data of the visualized holographic content corresponding to a display format of a display apparatus, wherein the display apparatus displays the holographic content of which the data format of the object data is converted in an optical method and feeds back a result of displaying the holographic content.

The generating may generate the holographic content in a successive for per temporal frame using the real object corresponding to a foreground or background, the virtual object corresponding to 3D model data and the lighting information on the virtual object.

The editing may divide the holographic content into small parts with a certain size to use distributed processing.

The editing may edit fringe information on order information on the object data in a format of the object data.

The editing may edit the holographic content to have an arrangement-based spherical form in view of bandwidth optimization and viewpoint shift of the object data.

The editing may edit the holographic content to enable an interaction with a user by applying a numerical reconstruction technique to the object data.

The advance-visualizing may conduct 3D rendering in view of light wave distribution of the edited holographic content.

The advance-visualizing may visualize the holographic content using a reconstruction simulation method based on numerical reconstruction when the holographic content of which the data format of the object data is optimized is visualized.

The converting may integrate the divided small parts with the certain size of the holographic content into unitary holographic content.

According to another aspect of the present invention, there is provided a holographic content providing method performed by a display apparatus, the method including: displaying holographic content optimized for a data format of the display apparatus, received from a holographic content providing apparatus, in an optical method; and feeding back a result of displaying the holographic content to the holographic content providing apparatus, wherein the holographic content providing apparatus converts a data format of object data of the holographic content based on distributed processing and provides the converted holographic content.

The displaying may display the holographic content through temporal multiplexing or spatial multiplexing by adjusting an arrangement of a flexible multiple light modulator.

The displaying may display the holographic content by matching a space for presenting the displayed holographic content and a user gesture recognition space to conduct an interaction between the holographic content and a user.

The feeding back may compare the holographic content reconstructed in the optical method by the display apparatus with holographic content advance-visualized in a numerical manner by the holographic content providing apparatus.

According to still another aspect of the present invention, there is provided a holographic content providing apparatus including: a generation unit to generate holographic content by capturing a real object, a virtual object and light information; an edition unit to edit the holographic content using object data of the generated holographic content; an advance visualization unit to advance-visualize a result of 3D rendering the holographic content; and a conversion unit to convert a data format of the object data of the visualized holographic content corresponding to a display format of a display apparatus, wherein the display apparatus displays the holographic content of which the data format of the object data is converted in an optical method and feeds back a result of displaying the holographic content.

The edition unit may divide the holographic content into small parts with a certain size to use distributed processing, and edit fringe information on order information on the object data in a format of the object data.

The edition unit may edit the holographic content to have an arrangement-based spherical form in view of bandwidth optimization and viewpoint shift of the object data.

The edition unit may edit the holographic content to enable an interaction with a user by applying a numerical reconstruction technique to the object data.

The advance visualization unit may conduct 3D rendering in view of light wave distribution of the edited holographic content, and visualize the holographic content using a reconstruction simulation method based on numerical reconstruction when the holographic content of which the data format of the object data is optimized is visualized.

The conversion unit may integrate the divided small parts with the certain size of the holographic content into unitary holographic content.

According to yet another aspect of the present invention, there is provided a display apparatus including a display unit to display holographic content optimized for a data format of the display apparatus, received from a holographic content providing apparatus, in an optical method; and a feedback unit to feed back a result of displaying the holographic content to the holographic content providing apparatus, wherein the holographic content providing apparatus optimizes a data format of object data of the holographic content based on distributed processing according to the data format of the display apparatus, and provides the optimized holographic content.

### Effect

According to embodiments, ultrahigh-image quality holographic content reflecting user storytelling and enabling experiential interactions may be created and managed in a level of creating digital hologram of a unitary form in a consistent manner.

Also, there is disclosed a creation tool for user created content (UCC) which enables digital holographic content to utilize a similar method to that of creating and managing conventional digital content, making it possible to produce digital holographic content in large quantities.

A new multimedia combined with a conventional multimedia market is suggested through the creation tool, contributing to creation and preoccupancy of the new market.

Digital holographic content of a virtual object may be captured, generated, composed and edited by applying a hybrid hologram content capturing and generating method employing a plurality of methods in parallel.

Digital holographic content may be provided timely to a holographic market environment when an optimized multiplatform adaptive digital holographic content conversion technique supporting even an optical reconstruction display apparatus of holographic content is employed.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a holographic content providing apparatus and a display apparatus according to an embodiment;

FIG. 2 illustrates a detailed configuration of a holographic content providing apparatus and a display apparatus according to an embodiment;

FIG. 3 illustrates each component involved in generating holographic content in detail according to an embodiment;

FIG. 4 is a flowchart illustrating a holographic content providing method of a holographic content providing apparatus according to an embodiment; and

FIG. 5 is a flowchart illustrating a holographic content providing method of a display apparatus according to an embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

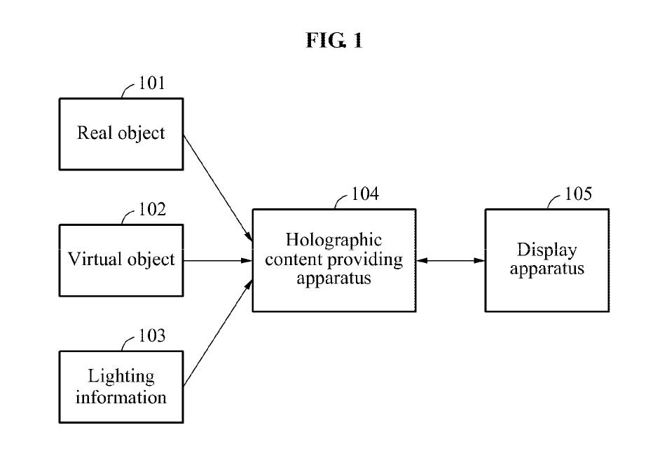

FIG. 1 illustrates a holographic content providing apparatus and a display apparatus according to an embodiment.

Referring to FIG. 1, the holographic content providing apparatus 104 may capture a real object 101, a virtual object 102, and lighting information 103. The real object 101 refers to an object with a shape to be used to form holographic content, which may include foreground or background information. For example, the real object 101 may include a person, an animal, a car, a building, a tree or the like, or information on surroundings of an object. The virtual object 102 may refer to additional information for maximizing quality of the holographic content of the real object 101. For instance, the virtual object 102 may include a person, an animal, a car, a building, a tree, or the like represented in a point cloud or a three-dimensional (3D) mesh model corresponding to the real object 101. The lighting information 103 may include information on a phase change of light reflected on surfaces of the real object 101 and the virtual object 102.

The holographic content providing apparatus 104 may generate holographic content of the real object 101 and the virtual object 102 using the real object 101, the virtual object 102 and the lighting information 103. Here, the holographic content providing apparatus 104 may generate holographic content in a successive form per time frame.

The holographic content providing apparatus 104 may build an object library with respect to the real object 101, the virtual object 102 and the lighting information 103 in order to manage the holographic content. That is, the holographic content providing apparatus 104 may perform a metadata-based labeling function on object data of the holographic content so as to perform a distributed management function, such as storage, classification and retrieval functions, and a management function in a stand-alone environment on the real object 101 and the virtual object 102, thereby building the object library.

The holographic content providing apparatus 104 may edit the holographic content using the generated holographic object data of the holographic content. In detail, the holographic content providing apparatus 104 may compose holographic contents of a background and a foreground or directly edit fringe data of the holographic content, thereby producing the holographic content.

The holographic content providing apparatus 104 may conduct 3D rendering on the edited holographic content to achieve advance visualization of the holographic content. The holographic content providing apparatus 104 may conduct 3D rendering in view of light wave distribution of the edited holographic content. The holographic content providing apparatus 104 may perform advance visualization of the 3D-rendered holographic content in a numerical reconstruction-based optical reconstruction simulation method.

The holographic content providing apparatus 104 may integrate divided small parts with a certain size of the holographic content into unitary holographic content.

The display apparatus 105 may display the holographic content of which a data format of the object data is converted from the holographic content providing apparatus 104 in an optical method and feed back a result of displaying the holographic content. Here, the display apparatus 105 may display the holographic content through temporal multiplexing or spatial multiplexing by adjusting an arrangement of a flexible multiple light modulator.

Here, the holographic content providing apparatus 104 and the display apparatus 105 may be present in a combination form or as separate devices. When the holographic content providing apparatus 104 and the display apparatus 105 are combined as a single unit, the holographic content providing apparatus 104 may autonomously display the holographic content, instead of transmitting the holographic content to the separate display apparatus 105.

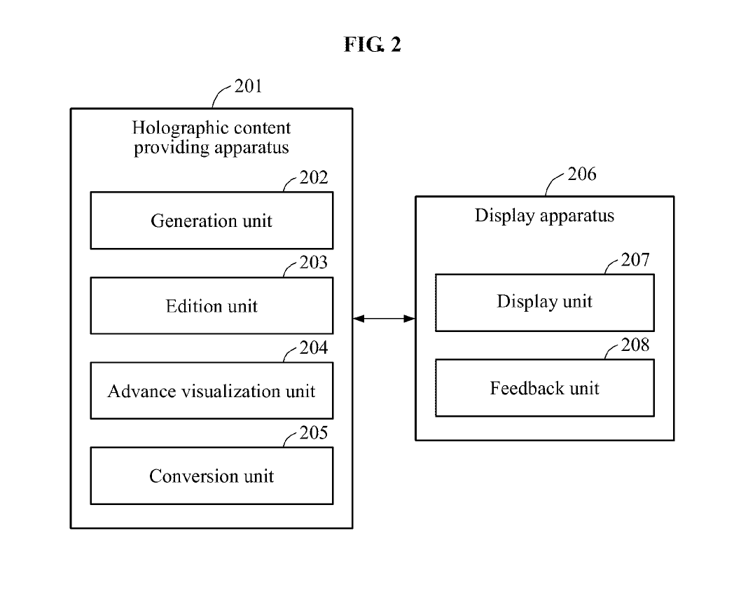

FIG. 2 illustrates a detailed configuration of a holographic content providing apparatus and a display apparatus according to an embodiment.

Referring to FIG. 2, the holographic content providing apparatus 201 may include a generation unit 202, an edition unit 203, an advance visualization unit 204, and a conversion unit 205.

The generation unit 202 may capture a real object, a virtual object and lighting information to generate holographic content. The generation unit 202 may capture ultrahigh-resolution holographic content of the real object by employing a hybrid method. For example, the generation unit 202 may capture the holographic content using hardware-based light scanning, a method of utilizing software algorithm-based light field information and a method of utilizing multi RGB-D information for capturing real-time holographic content of a real object.

The generation unit 202 may generate the virtual object by utilizing a computer graphics algorithm in order to maximize quality of the holographic content. The computer graphics algorithm may be an algorithm of generating a virtual object by applying a plurality of shading models, such as reflection and refraction models, depending on a surface of the virtual object and adding lighting information. Here, a 3D data model for the virtual model may include a point cloud, a 3D mesh model, or the like.

The generation unit 202 may generate the holographic content using the real object corresponding to a foreground or background, the virtual object corresponding to 3D model data, and the lighting information on the virtual object.

Here, the generation unit 202 may build up an object library for managing the real object, the virtual object and the holographic content. That is, the generation unit 202 may store the virtual object, the real object and the holographic content in order to utilize the holographic content in distributed and stand-alone environments based on a management function. To this end, the generation unit 202 may save the real object, the virtual object and the holographic content in a distributed manner by utilizing a high-capacity data format. The generation unit 202 may build up the object library convenient for management by performing a metadata-based labeling function. Here, the high-capacity data format may refer to a data format for the holographic content.

The edition unit 203 may edit the holographic content using object data of the holographic content. In detail, the edition unit 203 may divide the holographic content into small parts with a certain size in order to employ distributed processing for the holographic content. Also, the edition unit 203 may edit the holographic content using fringe information. Here, the fringe information may be order information on the object data as a format of the object data of the holographic content.

The edition unit 203 may use the fringe information so as to conveniently control the holographic content. The edition unit 203 may employ the fringe information as an authoring tool for editing the holographic content and reconsider user convenience and practicality of a producing tool. That is, the edition unit 203 may quickly generate arrangement-based holographic content for generating distributed processing-based large-screen holographic content and apply a numerical reconstruction technique thereto. Here, the edition unit 203 may adopt an application programming interface (API) for distributed processing of the holographic content.

The edition unit 203 may occlude a wide viewing angle of the holographic content for editing the wide viewing angle. The edition unit 203 may generate light wave technology-applied holographic content in all directions using holographic content in a spherical arrangement so as to edit the holographic content through bandwidth optimization and viewpoint shift.

The edition unit 203 may employ shading techniques of computer graphics for expressing reflection and refraction in order to edit the holographic content in a super-realistic manner and improve quality of the holographic content through the lighting information and a post-processing correction technique.

The advance visualization unit 204 may conduct 3D rendering on the object data of the holographic in the super-realistic manner to achieve advance visualization of the holographic content. To this end, the advance visualization unit 204 may intuitively conduct 3D rendering on light wave distribution of the holographic content to achieve advance visualization of the holographic content.

Also, the advance visualization unit 204 may play back the holographic content through numerical reconstruction of the holographic content. The present invention supposes that the holographic content providing apparatus is present with the display apparatus to display the holographic content in an optical method. Alternatively, the holographic content providing apparatus is capable of displaying the holographic content even in the absence of the display apparatus.

The conversion unit 205 may convert the data format of the object data of the visualized holographic content corresponding to a data format of the display apparatus. Here, the conversion unit 205 may distinguishably convert the object data of the holographic content depending on presence of the display apparatus and a display apparatus type. That is, the conversion unit 205 may convert the data format of the object data to support display apparatuses of different characteristics utilizing a spatial light modulator (SLM) with a multi-structure or single structure. That is, the conversion unit 205 may convert the object data into a multiplatform-based optimized data format supporting a plurality of display apparatuses.

The conversion unit 205 may match a characteristic of an optical element and a device for user-combined data format high-speed conversion based on distributed processing and conduct a function of adjusting user feedback-based conversion speed and quality. To this end, a transcoding function may be adopted in a distributed environment for supporting ultrahigh-capacity data processing and a multiplatform.

The conversion unit 205 may integrate divided small parts with a certain size of the holographic content into unitary holographic content. The conversion unit 205 may store the converted holographic content or transmit the holographic content to the display apparatus to store the holographic content.

The display apparatus 206 may include a display unit 207 and a feedback unit 208. The display unit 207 may display the holographic content optimized for the data format of the display apparatus 206 in the optical method. In detail, the display apparatus 207 may display large-screen holographic content with a wide viewing angle. To this end, the display unit 207 may display the holographic content through temporal multiplexing or spatial multiplexing by adjusting an arrangement of a flexible multiple light modulator.

For instance, the display apparatus 206 may support a large screen, ultrahigh resolution and a wide viewing angle, and display full-parallax full-color holographic content in the optical method.

Further, the display unit 207 may adopt a technique for an interaction between the holographic content and a user. That is, the display unit 207 may match a space for presenting the holographic content displayed by the display apparatus and a user gesture recognition space. For instance, the display unit 207 may employ a multimodal interface technique for interactions between the holographic content and the user.

The feedback unit 208 may feed a result of displaying the holographic content back to the holographic content providing apparatus. That is, the feedback unit 208 may compare the holographic content reconstructed in the optical method by the display apparatus with the holographic content visualized in advance in the numerical manner by the holographic content providing apparatus.

That is, the feedback unit 208 may compare qualities of the holographic content reconstructed in the optical method with the holographic content visualized in advance and evaluate objective or subjective image qualities of the holographic contents. The feedback unit 208 may feed the result back to the holographic content providing apparatus in order to improve the quality of the holographic content reconstructed by the display apparatus.

That is, the feedback unit 208 may verify reconstruction of the holographic contents reconstructed in the different methods.

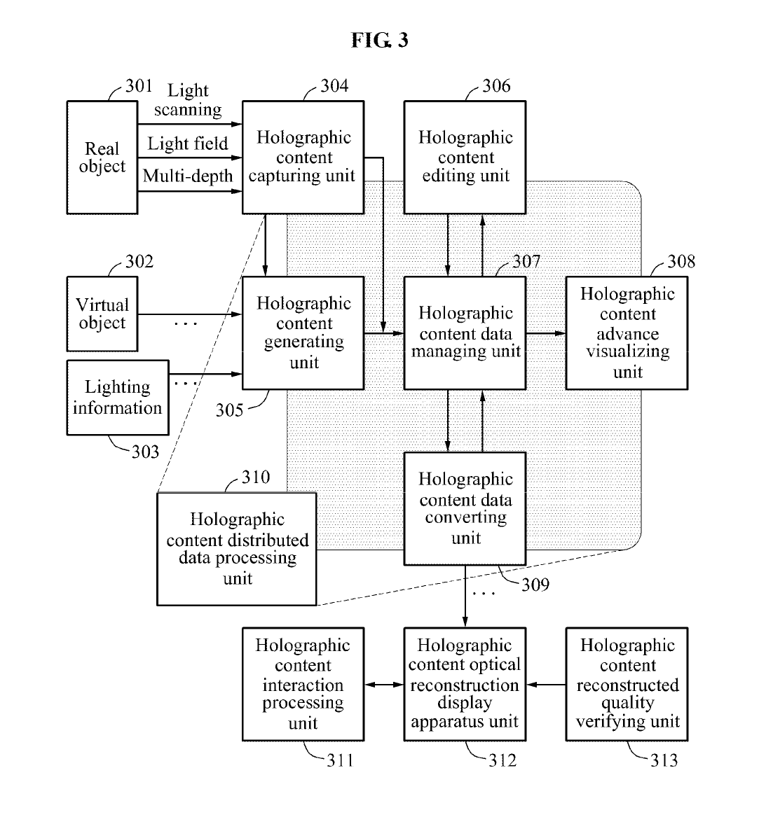

FIG. 3 illustrates each component involved in generating holographic content in detail according to an embodiment.

Referring to FIG. 3, a holographic content providing apparatus may include a holographic content capturing unit 304, a holographic content generating unit 305, a holographic content editing unit 306, a holographic content data managing unit 307, a holographic content advance visualizing unit 308, a holographic content data converting unit 309, and a holographic content distributed data processing unit 310.

The holographic content capturing unit 304, the holographic content generating unit 305, and the holographic content data managing unit 307 may correspond to the generation unit 202 of the holographic content providing apparatus 201 of FIG. 2.

The holographic content capturing unit 304 may capture a real object 301 using a hybrid method including light scanning, a light field input technique and a multi-depth image technique. Here, the holographic content capturing unit 304 may capture the real object 301 based on focus and view changes.

The holographic content generating unit 305 may acquire a virtual object 302 by employing a 3D data model, such as a point cloud model and a mesh model, lighting information 303, and a 3D graphics algorithm of a shading model. The holographic content generating unit 305 may generate ultrahigh-quality holographic content using the real object 301 captured by the holographic content capturing unit 304 and the virtual object.

The holographic content data managing unit 307 may receive the real object, the virtual object and the holographic content from the holographic content capturing unit 304 and the holographic content generating unit 305. The holographic content data managing unit 307 may distributed-process the real object, the virtual object and the holographic content to conduct a management function, such as storage, classification and retrieval, or manage the real object, the virtual object and the holographic content to be performed in a stand-alone environment.

To this end, the holographic content data managing unit 307 may process the real object, the virtual object and the holographic content by applying a data form to the holographic content. The holographic content data managing unit 307 may build up an object library to manage, for example, store, classify and retrieve, object data of the holographic content. The holographic content data managing unit 307 may build up the object library through a metadata-based data labeling method.

The holographic content editing unit 306 may correspond to the edition unit 203 of the holographic content providing apparatus 201 of FIG. 2. The holographic content editing unit 306 may directly edit and compose fringe data that is a stored form of the holographic content with respect to the object data of the holographic content captured with respect to the real object 301 and the virtual object 302. Here, the holographic content editing unit 306 may provide a graphic user interface (GUI)-based authoring tool for convenience of the user in utilizing functions of directly editing and composing the fringe data.

For example, the holographic content editing unit 306 may provide a node processing-based user interface function in order to edit and compose the object data of the holographic content.

The holographic content editing unit 306 may generate holographic content with a wide viewing angle using wide viewing angle occlusion, bandwidth optimization and spherical holographic content based on viewpoint shift.

Also, the holographic content editing unit 306 may edit and compose large-scale holographic content based on parallel distributed processing in order to process ultrahigh-capacity holographic content. Here, the holographic content editing unit 306 may edit and compose the large-scale holographic content by quickly generating and reconstructing diversifying arrangement-based holographic content or by conducting parallel distributed processing on ultrahigh-resolution content using a major node in a distributed cluster form.

The holographic content editing unit 306 may provide a user with a function of intuitively editing the holographic content and provide shift, rotation, enlargement/reduction, matching, stitching, background subtraction and actual image/virtual image composition functions.

For instance, the holographic content editing unit 306 may provide a function of composing panoramic holographic content using holographic content stitching.

The holographic content advance visualizing unit 308 may correspond to the advance visualization unit 304 of FIG. the holographic content providing apparatus 201 of FIG. 2. The holographic content advance visualizing unit 308 may employ advance visualization of the holographic content into a 3D form in an intuitive manner according to light wave distribution on the basis of advance visualization of the object data of the holographic content in a numerical manner.

Here, the holographic content advance visualizing unit 308 may use an analysis processing-based holographic content authoring tool in order to conveniently achieve advance visualization of the holographic content. The holographic content authoring tool may be provided as a plug-in form having an editing function applicable to a conventional 3D edition tool so as to utilize computer graphics technology. Further, the holographic content authoring tool may be implemented in a conventional script language, for example, Python, and provide an API library for the language.

The holographic content data converting unit 309 may correspond to the conversion unit 205 of the holographic content providing apparatus 201 of FIG. 2. The holographic content data converting unit 309 may convert a data format of the holographic content corresponding to a display apparatus capable of displaying the holographic content in an optical method. That is, the holographic content data converting unit 309 may adaptively convert the data format depending on a platform suitable for the display apparatus.

For example, the holographic content data converting unit 309 may convert the data format adaptively to a multiplatform enabling the display apparatus to display the holographic content. Here, the display apparatus may display the holographic content in the optical method of the holographic content with respect to the object data of the holographic content. Alternatively, the display apparatus may connect to a network environment to display the holographic content using a method of implementing a conversion function for optical display of the holographic content.

The holographic content distributed data processing unit 310 may correspond to the components organically operating in the holographic content providing apparatus 201. The holographic content distributed data processing unit 310 may conduct signal processing to organically operate based on operations of the respective units. That is, the holographic content distributed data processing unit 310 may provide middleware to be implemented in a parallel distributed environment for signal processing, such as capturing, generating, editing, advance-visualizing and converting the holographic content.

To this end, the holographic content distributed data processing unit 310 may provide an API for distributed data processing with respect to middleware-level holographic content. In addition, the holographic content distributed data processing unit 310 may support a script function, for example Python, for scalability and convenience of each unit.

The display apparatus may include a holographic content optical reconstruction display apparatus unit 312, a holographic content interaction processing unit 311, and a holographic content reconstructed quality verifying unit 313.

The holographic content optical reconstruction display apparatus unit 312 and the holographic content interaction processing unit 311 may correspond to the display unit 207 of the display apparatus 206 of FIG. 2. The holographic content optical reconstruction display apparatus unit 312 may display the holographic content, optimized for a data format of the display apparatus, received from the holographic content providing apparatus in the optical method.

The holographic content optical reconstruction display apparatus unit 312 may divide the object data of the holographic content in a unitary form into small parts with a certain size and convert the object data in a distributed processing manner. The holographic content optical reconstruction display apparatus unit 312 may integrate the object data of the holographic content divided based on distributed processing according to the data format of the display apparatus to provide the unitary holographic content.

Here, the holographic content optical reconstruction display apparatus unit 312 may provide the unitary holographic content through automatic matching of the holographic content according to optical information on the display apparatus, such as a light modulator.

The holographic content optical reconstruction display apparatus unit 312 may display the holographic content through a user interface, a conversion tool and a conversion tool server adaptively changing based on the multiplatform.

The holographic content interaction processing unit 311 may adjust user feedback-based conversion speed and/or quality. That is, the holographic content interaction processing unit 311 may match a space for presenting the displayed holographic content and a user gesture recognition space to perform an interaction between the holographic content and a user, thereby displaying the holographic content with definite quality.

That is, the holographic content interaction processing unit 311 may match the spaces in a user-customized manner based on a user manipulation to provide the holographic content converted according to a user request.

The holographic content reconstructed quality verifying unit 313 may correspond to the feedback unit 208 of the display apparatus 206 of FIG. 2. The holographic content reconstructed quality verifying unit 313 may compare the holographic content reconstructed in the optical method by the display apparatus with the holographic content visualized in advance in the numerical manner by the holographic content providing apparatus. The holographic content reconstructed quality verifying unit 313 may feed back a comparison result for quality improvement. Also, the holographic content reconstructed quality verifying unit 313 may verify quality of the reconstructed holographic content through the comparison result.

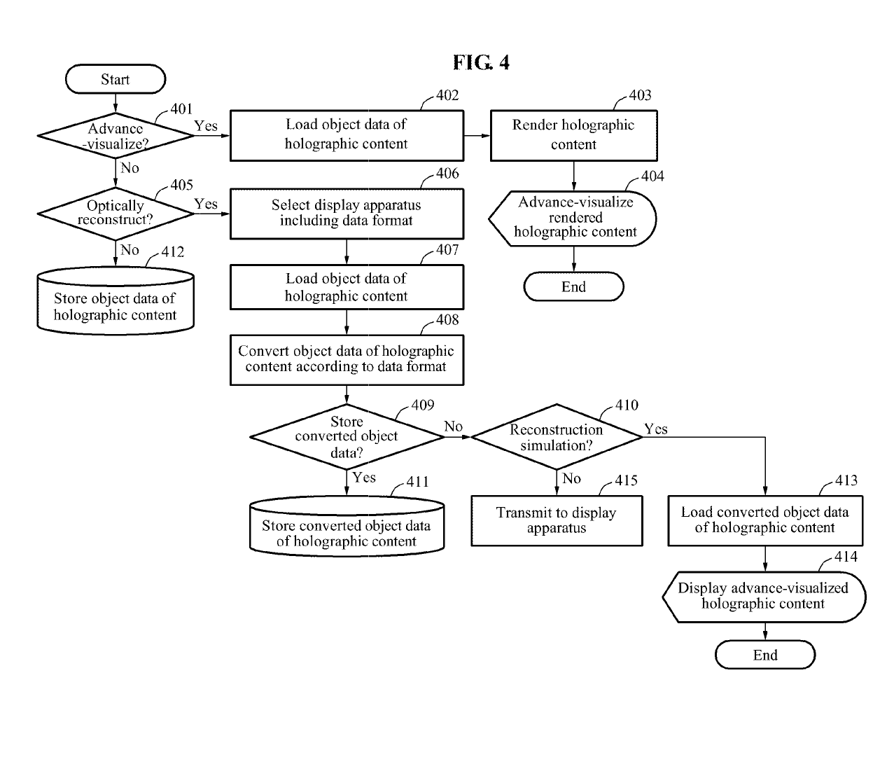

FIG. 4 is a flowchart illustrating a holographic content providing method of a holographic content providing apparatus according to an embodiment.

FIG. 4 may be a flowchart illustrating a process that the holographic content providing apparatus generates holographic content using a real object, a virtual object and lighting information and conducts advance visualization or optical reconstruction of the generated holographic content.

In operation 401, the holographic content providing apparatus may verify, using object data of the generated holographic content, whether advance visualization is carried out. Here, when advance visualization is carried out (Yes), the holographic content providing apparatus may load the object data of the holographic content into a storage unit in operation 402. Here, the storage unit may be a separate holographic content server or a database located in the holographic content.

In operation 403, the holographic content providing apparatus may render the holographic content. The holographic content providing apparatus may conduct rendering in view of light wave distribution of the holographic content. Here, the holographic content providing apparatus may conduct an operation for advance visualization of the object data of the holographic content. That is, the holographic content providing apparatus may conduct an operation for verifying quality of the holographic content generated through the real object, the virtual object and the lighting information before optical reconstruction.

In operation 404, the holographic content providing apparatus may conduct advance visualization of the rendered holographic content. The holographic content providing apparatus may conduct advance visualization of the holographic content visually using a 3D computer graphics algorithm, for example, ultrahigh-speed volume rendering, instead of optical reconstruction.

Here, the holographic content providing apparatus may conduct a software computation operation according to the 3D computer graphic algorithm, thereby achieving advance visualization of the holographic content in a user-desired form based on creative storytelling of the user. The holographic content providing apparatus may conduct advance visualization of the holographic content based on storytelling of the user, thereby achieving advance visualization of the holographic content in an interactive form enabling interactions between the user and the holographic content.

When advance visualization is not carried out (No), the holographic content providing apparatus may verify whether to optically reconstruct the holographic content in operation 405. When optical reconstruction is not carried out (No), the holographic content providing apparatus may store the object data of the generated holographic content in the storage unit in operation 412.

When optical reconstruction is carried out (Yes), the holographic content providing apparatus may select a display apparatus to display the holographic content in operation 406. Here, the display apparatus may include a unique data format for displaying the holographic content. That is, the holographic content providing apparatus may select the data format for displaying the holographic content.

In operation 407, the holographic content providing apparatus may load the object data of the holographic content from the storage unit.

In operation 408, the holographic content providing apparatus may convert the object data of the holographic content according to the data format of the selected display apparatus. The holographic content providing apparatus may convert the holographic content to reflect hardware characteristics of the display apparatus according to the data format.

That is, the holographic content providing apparatus may convert the holographic content according to a type of the display apparatus generated based on a single SLM or multiple SLM. That is, the holographic content providing apparatus may convert the holographic content adaptively to hardware characteristics of the display apparatus formed according to a form of an SLM.

In operation 409, the holographic content providing apparatus may verity whether the object data, converted into the data format of the display apparatus, is stored. When the converted object data is stored (Yes), the holographic content providing apparatus may store the converted object data in the storage unit.

On the contrary, when the converted object data is not stored (No), the holographic content providing apparatus may verify whether a reconstruction simulation is carried out in operation 410. When the reconstruction simulation is carried out (Yes), the holographic content providing apparatus may load the converted holographic content in operation 413. Here, the converted holographic content may be the advance-visualized holographic content that is 3D rendered content.

In operation 414, the holographic content providing apparatus may conduct advance visualization of the 3D rendered holographic content in an optical reconstruction simulation method based on numerical reconstruction.

When the reconstruction simulation is not carried out (No), the holographic content providing apparatus may transmit the holographic content to the display apparatus in operation 415.

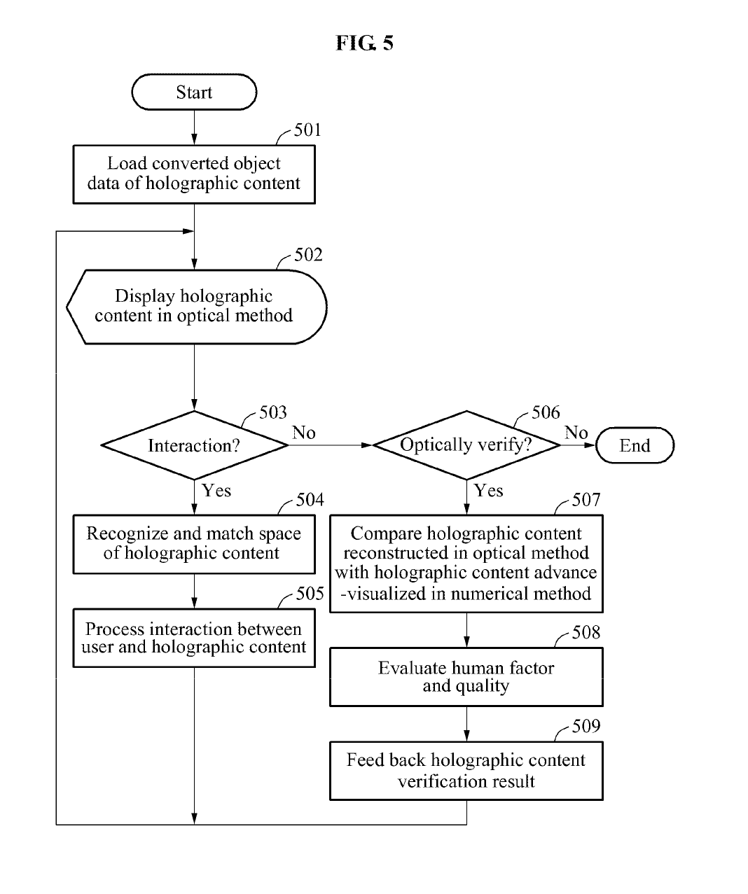

FIG. 5 is a flowchart illustrating a holographic content providing method of a display apparatus according to an embodiment.

Referring to FIG. 5, the display apparatus may operate when a holographic content providing apparatus does not carried out a reconstruction simulation.

In operation 501, the display apparatus may load converted holographic content from the holographic content providing apparatus.

In operation 502, the display apparatus may display the loaded holographic content in an optical method.

In operation 503, the display apparatus may verify whether there is an interaction between a user and the displayed holographic content. When there is an interaction (Yes), the display apparatus may match a space for presenting the displayed holographic content in operation 504.

In operation 505, the display apparatus may match the space for presenting the displayed holographic content with a user gesture recognition space according to the interaction between the user and the holographic content. The display apparatus may process the holographic content whose space is matched to be reflected on the displayed holographic content. That is, the display apparatus may refresh the holographic content to be re-displayed.

When there is no interaction (No), the display apparatus may conduct optical verification of the holographic content in operation 506. When optical verification is carried out (Yes), the display apparatus may compare advance-visualized holographic content in an optical reconstruction simulation method based on numerical reconstruction with holographic content reconstructed via the optical method in operation 507.

Here, the advance-visualized holographic content may be content visualized in terms of software, while the holographic content reconstructed via the optical method may be content visualized in terms of hardware. Here, although different visualization methods are used, the holographic contents are represented visually and thus are possibly compared with each other.

In operation 508, the display apparatus may evaluate and process human factors and qualities of the respective holographic contents. Here, the display apparatus may objectively or subjectively evaluate each of the holographic contents.

In operation 509, the display apparatus may feed back a result of comparing the holographic contents. The display apparatus may process the comparison result to be reflected on the holographic contents. That is, the display apparatus may refresh and re-display the holographic contents.

The methods according to the embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention.

Therefore, the scope of the present invention is not limited to the foregoing exemplary embodiments but is defined by the claims and their equivalents.

What is claimed is:

1. A holographic content providing method based on distributed processing performed by a holographic content providing apparatus, the method comprising:
generating holographic content by capturing a real object, a virtual object and light information;
editing the holographic content using object data of the generated holographic content;
advance-visualizing a result of three-dimensional (3D) rendering the holographic content; and
converting a data format of the object data of the visualized holographic content corresponding to a display format of a display apparatus,
wherein the display apparatus displays the holographic content of which the data format of the object data is converted in an optical method and feeds back a result of displaying the holographic content.

2. The method of claim 1, wherein the generating generates the holographic content in a successive for per temporal frame using the real object corresponding to a foreground or background, the virtual object corresponding to 3D model data and the lighting information on the virtual object.

3. The method of claim 1, wherein the editing divides the holographic content into small parts with a certain size to use distributed processing.

4. The method of claim 1, wherein the editing edits fringe information on order information on the object data in a format of the object data.

5. The method of claim 1, wherein the editing edits the holographic content to have an arrangement-based spherical form in view of bandwidth optimization and viewpoint shift of the object data.

6. The method of claim 1, wherein the editing edits the holographic content to enable an interaction with a user by applying a numerical reconstruction technique to the object data.

7. The method of claim 1, wherein the advance-visualizing conducts 3D rendering in view of light wave distribution of the edited holographic content.

8. The method of claim 7, wherein the advance-visualizing advance-visualizes the 3D rendered holographic content in an optical reconstruction simulation method based on numerical reconstruction.

9. The method of claim 3, wherein the converting integrates the divided small parts with the certain size of the holographic content into unitary holographic content.

10. A holographic content providing method performed by a display apparatus, the method comprising:
displaying holographic content optimized for a data format of the display apparatus, received from a holographic content providing apparatus, in an optical method; and
feeding back a result of displaying the holographic content to the holographic content providing apparatus,
wherein the holographic content providing apparatus converts a data format of object data of the holographic content based on distributed processing and provides the converted holographic content.

11. The method of claim 10, wherein the displaying displays the holographic content through temporal multiplexing or spatial multiplexing by adjusting an arrangement of a flexible multiple light modulator.

12. The method of claim 10, wherein the displaying displays the holographic content by matching a space for presenting the displayed holographic content and a user gesture recognition space to conduct an interaction between the holographic content and a user.

13. The method of claim 10, wherein the feeding back compares the holographic content reconstructed in the optical method by the display apparatus with holographic content advance-visualized in a numerical manner by the holographic content providing apparatus.

14. A holographic content providing apparatus comprising:
a generation unit to generate holographic content by capturing a real object, a virtual object and light information;
an edition unit to edit the holographic content using object data of the generated holographic content;
an advance visualization unit to advance-visualize a result of three-dimensional (3D) rendering the holographic content; and
a conversion unit to convert a data format of the object data of the visualized holographic content corresponding to a display format of a display apparatus,
wherein the display apparatus displays the holographic content of which the data format of the object data is converted in an optical method and feeds back a result of displaying the holographic content.

15. The holographic content providing apparatus of claim 14, wherein the edition unit divides the holographic content into small parts with a certain size to use distributed processing, and edits fringe information on order information on the object data in a format of the object data.

16. The holographic content providing apparatus of claim 14, wherein the edition unit edits the holographic content to have an arrangement-based spherical form in view of bandwidth optimization and viewpoint shift of the object data.

17. The holographic content providing apparatus of claim 14, wherein the edition unit edits the holographic content to enable an interaction with a user by applying a numerical reconstruction technique to the object data.

18. The holographic content providing apparatus of claim 14, wherein the advance visualization unit conducts 3D rendering in view of light wave distribution of the edited holographic content, and advance-visualizes the 3D rendered holographic content in an optical reconstruction simulation method based on numerical reconstruction.

19. The holographic content providing apparatus of claim 15, wherein the conversion unit integrates the divided small parts with the certain size of the holographic content into unitary holographic content.

20. A display apparatus comprising:
a display unit to display holographic content optimized for a data format of the display apparatus, received from a holographic content providing apparatus, in an optical method; and
a feedback unit to feed back a result of displaying the holographic content to the holographic content providing apparatus,
wherein the holographic content providing apparatus optimizes a data format of object data of the holographic content based on distributed processing according to the data format of the display apparatus, and provides the optimized holographic content.
